(19) United States
(12) Patent Application Publication
(10) Pub. No.: US 2009/0277380 A1
(43) Pub. Date: Nov. 12, 2009

(54) METHOD AND APPARATUS TO COAT EPS FOAM CORED MOULDINGS

(76) Inventor: David A. Schmidt, (US)

Correspondence Address: David A. Schmidt, 1204 Centre Street, Fenwick, ON, L0S 1C0, CA

(21) Appl. No.: 12/118,660

(22) Filed: May 9, 2008

(51) Int. Cl. B05B 13/02

(52) U.S. Cl. 118/305

(57) ABSTRACT

A method and apparatus to coat preformed polystyrene cores with a layer of stucco-like material. The apparatus includes a coating chamber which is adjustable vertically and horizontally to suit the core height and width and includes a knife guide to maintain straightness of the core. Three chains with teeth drive the cores through the apparatus. The three chains can be individually raised or lowered to engage the core from the bottom by a depth suited to the core thickness. A roller table provides a low friction surface to ride on as the core is guided with guide fences and held down with wheels. The cores are placed close to the operator side for easy access.

### FIELD OF THE INVENTION

The invention relates to decorative mouldings and features used in the construction industry. The mouldings are comprised of expanded polystyrene (EPS) foam cores with a coating of stucco/plaster. The invention is a method and apparatus for coating the outside surface of the cores with stucco/plaster or any similar cementatious material.

### BACKGROUND OF THE INVENTION

Decorative mouldings, columns and featured are commonly comprised of EPS foam cores coated with stucco-like materials, providing a colorful and durable decorative finished surface.

The EPS foam cores are cut out of a block with a computer controlled hot wire machine, producing elongate foam cores. These foam cores can be reinforced with fiber meshing prior to coating.

More and more it is becoming common to coat the moulding cores by mechanical means, rather than applying the coating by hand.

One mechanical method of coating the cores is disclosed in Canadian patent application serial number 2229933 filed on Feb. 19, 1998 by Oscar et al. Disclosed is an apparatus with a pair of spiked conveyor belts, driving the foam core from the bottom surface through a pressurized coating chamber. An elongate dovetail rail on the apparatus engages a corresponding dovetail cut out on the bottom of the core, constraining the core laterally and vertically as it is coated. As disclosed, the apparatus would be costly, especially because of the pressurized coating chamber, which requires the additional expense of a pumping unit. The apparatus is designed so the cores must be centralized on the apparatus, making it sometimes difficult to reach by the operator. Some cores are not continuous and flat on the bottom and are cut out. If the cut out ends up over the dovetail rail, the apparatus cannot drive the core through.

Another mechanical method of coating the cores is disclosed in Canadian patent application serial number 2457085 filed on Feb. 5, 2004 by David Schmidt. This application discloses two embodiments for driving the cores through the coating chamber. One with a single attachment chain penetrating the bottom of the core with driving teeth and the other with a single attachment chain and side conveyors clamping to the sides of the cores. The first embodiment discloses positionable angle iron guide fences to locate and constrain the core laterally. The second embodiment discloses that the side conveyors positions and locates the foam laterally. Both embodiments disclose a flat table section supporting the core prior to entry into the coating chamber. Both embodiments disclose guide wheel assemblies inside the coating chamber to constrain the cores laterally and vertically as they are advanced through. Both embodiments disclose hold down wheels, pushing the foam core down on to the table top, while being engaged by the drive chain teeth.

There are a number of problems with the apparatus as shown. One is that in the case that the foam cores are covered with mesh, the mesh extends under the core. The mesh is sticky and when pushed down against a flat table, it tends to stick, thus making it too difficult to push the core through the coating chamber without having the drive teeth slip and shred the bottom of the soft foam core. Second being that the driving teeth attached to the attachment chain can protrude through the foam cores if they are thin, thus limiting the capability to coat thinner mouldings. Thirdly, the machine is designed so that the cores must be positioned centrally on the table, to engage with the drive teeth, making them hard to reach for the operator. Fourthly, some mouldings are not continuous and flat on the bottom and are cut out. If the cut out ends up over the drive teeth, the first embodiment machine can't drive the moulding through. Fifthly, the guide wheels in the coating chamber in both embodiments only provide point contact on the corners of the core. Any variation in the cut foam height or width will cause the foam to either be jammed tight against the wheels, or loose causing movement.

Another apparatus for coating the cores is disclosed in U.S. Pat. No. 6,974,502 dated Dec. 13, 2005 by David Schmidt. This patent disclosed a coating chamber and templates to produce decorative mouldings. Disclosed is that three separate sized coating chambers are required to coat a range of cores up to 36 inches wide. If the large coating chamber were used for small 4 inch mouldings, an inordinate amount of free space would have to be filled with coating material. An apparatus requiring three coating chambers to accomplish a range of up to 36 inches would be costly. Additionally, no method for constraining the cores laterally inside the coating chamber is disclosed. The cores as they exit the coating chamber will kick off to the side and will be apparent on the coated core as a miss-match at the end.

Therefore, this invention is aimed at solving the difficulties of the prior art by:
Providing an economical coating chamber that does not require pressurization and is adjustable in width and height to coat cores ranging from 2 inches to 36 inches wide.
Providing the ability for the core to be placed in the apparatus off center, so that it can be easily reached by the operator.
Providing multiple drive options to allow coating cores with elongate cut outs in the bottom.
Providing a guide in the coating chamber, independent of the table center and positionable to avoid core bottom cut outs.
Providing a roller table surface to reduce the friction that is encountered between the mesh and the core.

### SUMMARY OF THE INVENTION

Therefore, to this end, an object of the present invention is to provide a new innovative apparatus and method for applying a plaster/stucco-like material to the surfaces of an elongate foam core. The foam core is preformed with a profile resembling the desired finish profile with or without reinforcing mesh applied to the surface prior to coating.

The foam core can be used for decorative architectural mouldings.

Accordingly, the present invention is to disclose an apparatus to coat EPS foam cored mouldings with a plaster/stucco-like material, said apparatus comprising:
An adjustable coating chamber with a coating range of 2 inches to 36 inches wide and adjustable in height for cores up to 18 inches high. The height adjustment includes a 10 inch space above the core, which when filled with coating material, provides enough pressure that an external pumping system is not required.
A roller table with three cut out drive sections and fence guides, allowing the positioning of the core close to the inboard operator side. The three drive sections are positioned to allow driving cores that may even have elongate cut outs. The roller table reduces the friction encountered with flat tables.
Three drive chains with attached teeth that engage the bottom of the core and can be adjusted up and down to be completely below the table or up to penetrate the bottom of the core. The penetration depth is adjustable to accommodate thin cores, without punching through them.
A knife guide that engages a pre-cut slot in the bottom of the core. The guide is inside the coating chamber and is independent of the center of the apparatus and positionable to avoid cut outs that are present in certain types of cores.

Accordingly, the present invention discloses a method to coat EPS foam cored mouldings with a plaster/stucco-like material, comprising the steps of:
Positioning the foam core on a roller table, utilizing one, two or three drive chains with penetrating drive teeth to engage the bottom of the core
Positioning guide fences that constrain the said core laterally, so that it may be advanced straight and square to the opening in the coating chamber and parallel to the axis of the roller table.
Selecting and adjusting a coating chamber height, on the adjustable coating chamber assembly, to allow a minimum of 10 inches of coating material above the said foam core.
Adjusting the coating chamber width, on the adjustable coating chamber assembly, to suit the foam core so that there is only an optimum clearance on each inside sidewall, eliminating wasted space that may accumulate coating material that would otherwise begin to cure in the coating chamber.
Attaching an input and output metal template, premade to the adjusted hopper width and height. Alternately the templates may be acrylic, up to ¾ inch thick. Alternately, the templates may be XPS foam (blue board) up to 1 inch thick.
Sliding the coating chamber assembly laterally on slotted rails to align with the constrained core to the edges of the templates.
Positioning a bottom knife plate to align with the bottom slot in the foam core.
Positioning bottom plates, to rest on the said slotted rails, in each inside corner of the coating chamber.
Positioning additional bottom plates to provide support to the foam core if required by virtue of the width and thickness of the foam core.
Positioning the templates vertically to allow for the desired coating thickness on the core.
Positioning hold down wheels to keep the foam core engaged with the roller table.
Raising one or more drive chains with drive teeth to penetrate the underside of the foam core, to a height not protruding through the foam core.
Advancing the foam core so that the leading end projects past the output template by a distance of approximately ¼ inch.
Filling the coating chamber with coating material and keeping it filled.
Engaging the drive motor in the forward direction so that the core is advanced through the coating chamber.
Inserting a plurality of elongate foam cores, abutting end to end into the apparatus, one after the other.
Removing the coated foam cores as they exit form the coating chamber.
Leaving the coated foam cores to dry on a rack or table.

### BRIEF DESCRIPTION OF THE DRAWINGS

FIG. 1 is a perspective view of the apparatus 100 of the present invention, showing a foam core advancing through the apparatus.

FIG. 2 is a perspective view of a decorative moulding dissected by layer, revealing the core, mesh and coating layer being applied by the invention.

FIG. 3 is a perspective view of the apparatus roller table, along with the guide fences used to constrain the core laterally. The coating chamber and the three drive chains are removed for clarity.

FIG. 4 is a perspective view illustrating the hold down wheel assemblies and roller table with the coating chamber removed.

FIG. 5 is a perspective view of a drive chain lifting sub-assembly removed from the apparatus.

FIG. 6 is an end view inside the coating chamber assembly showing the core as it advances through the coating chamber.

FIG. 7 is three perspective views of the coating chamber assembly, illustrating the vertical and horizontal adjustability.

FIG. 8 is a perspective view showing the coating chamber assembly components.

FIG. 9 is an end view of the output template.

### DETAILED DESCRIPTION OF THE PREFERRED EMBODIMENTS

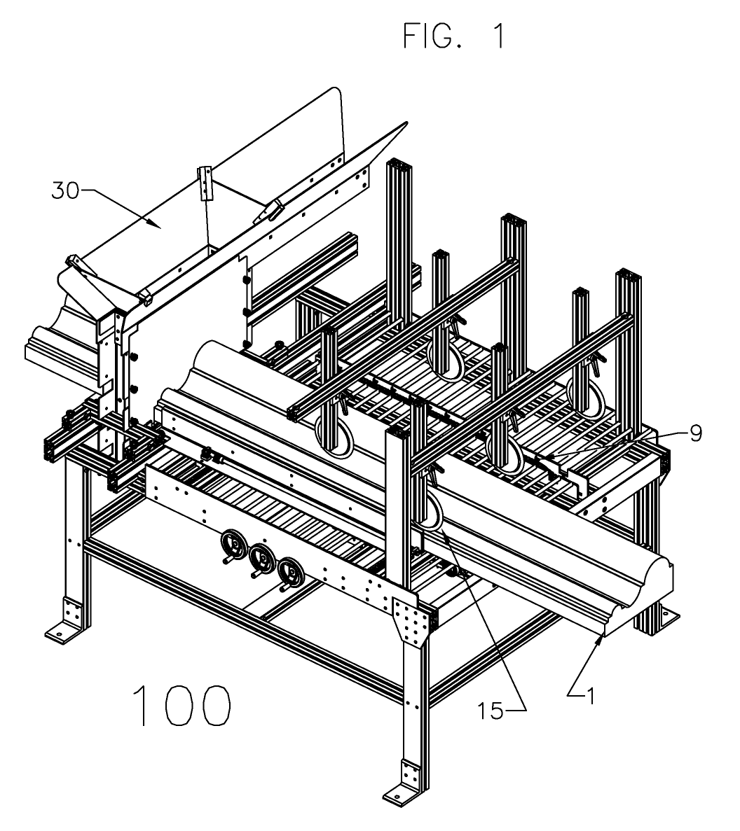

Referring to FIG. 1, there is illustrated apparatus 100 of the present invention in which a decorative moulding 1 is coated. Visible are one of the drive chains 9 and the coating chamber 30 and an arrangement of hold down wheels 15.

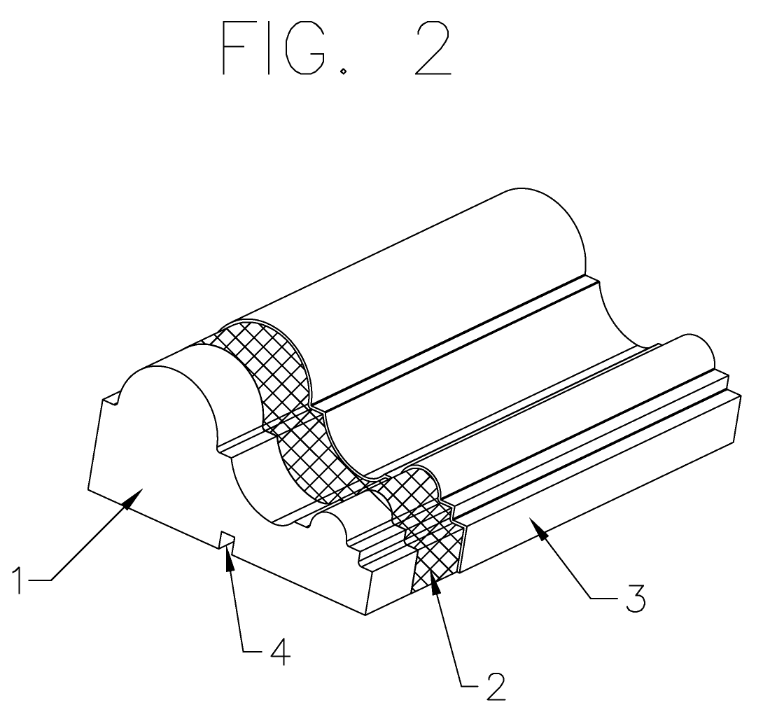

Referring to FIG. 2, the workpiece comprises a core 1 having a layer of fiber mesh 2 coated with a surface with an alignment slot 4 and is elongate and consistent through its entire length.

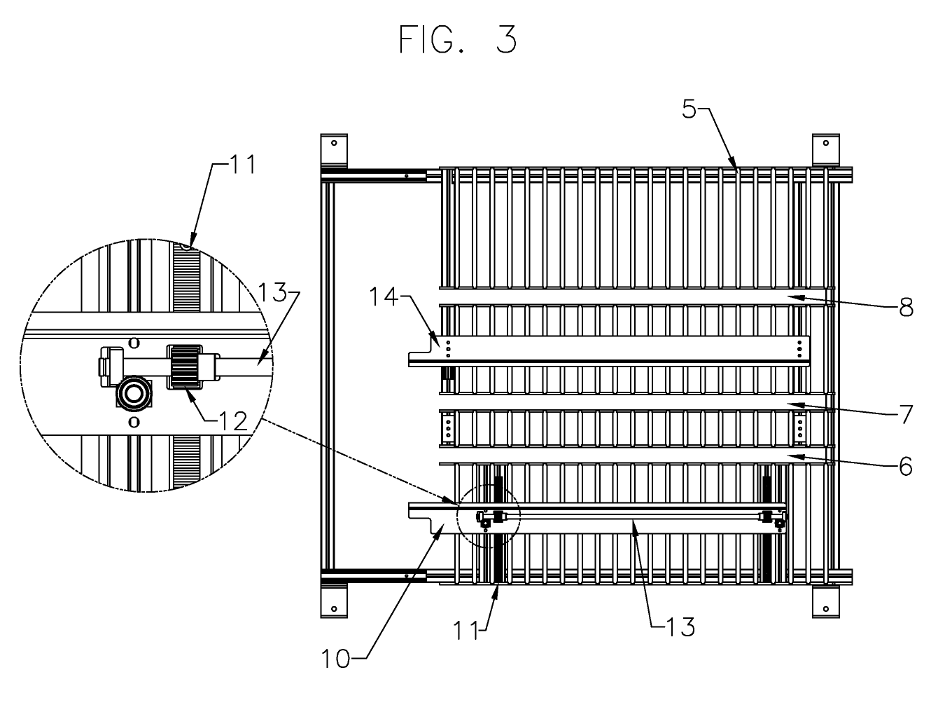

Referring to FIG. 3 is the roller table consisting of rollers 5 and open sections 6, 7, & 8. In each of the open sections, attachment chains 9 with drive teeth are available to advance the foam core. The foam core 1 can be positioned over chain is slot 6, or slots 6 & 7, or slots 6, 7, & 8. Slot 6 is used for narrow cores, 6 & 7 for wider cores and 6, 7, & 8 for the widest. Cores with bottom cutouts can also be accommodated using the different arrangement of drive chains available. The inboard guide fence 10 positions the core 1 laterally on the inboard side of the core. The racks 11 engage with pinions 12, which are connected together with axle 13, maintains that the inboard guide fence 10 moves horizontal and parallel to the advancement of the core 1. Guide fence 10 is adjustable from the inboard edge of the table to the open section 6. The outboard guide fence 14 is butt up against the side of core 1, which is parallel to the travel because of fence 10. The guide fence 14 is used anywhere along the roller table except the area controlled by guide fence 10.

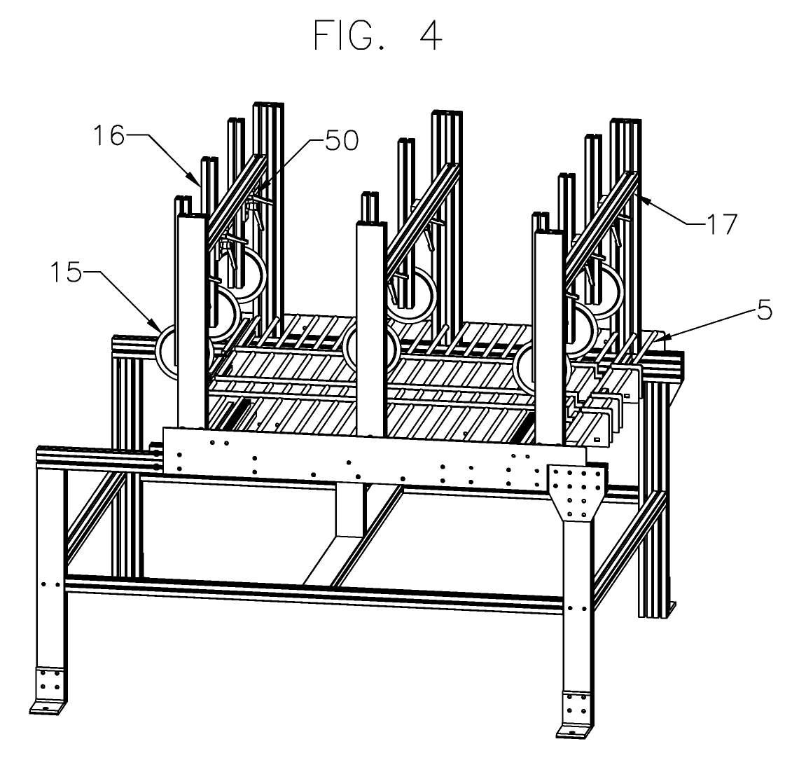

Referring to FIG. 4, hold down wheel 15 constrains the core 1 against the rollers 5. The hold down wheel is connected to slotted extrusion 16 which can be slid vertically on tee 50, which together can slide horizontally on slotted extrusion 17.

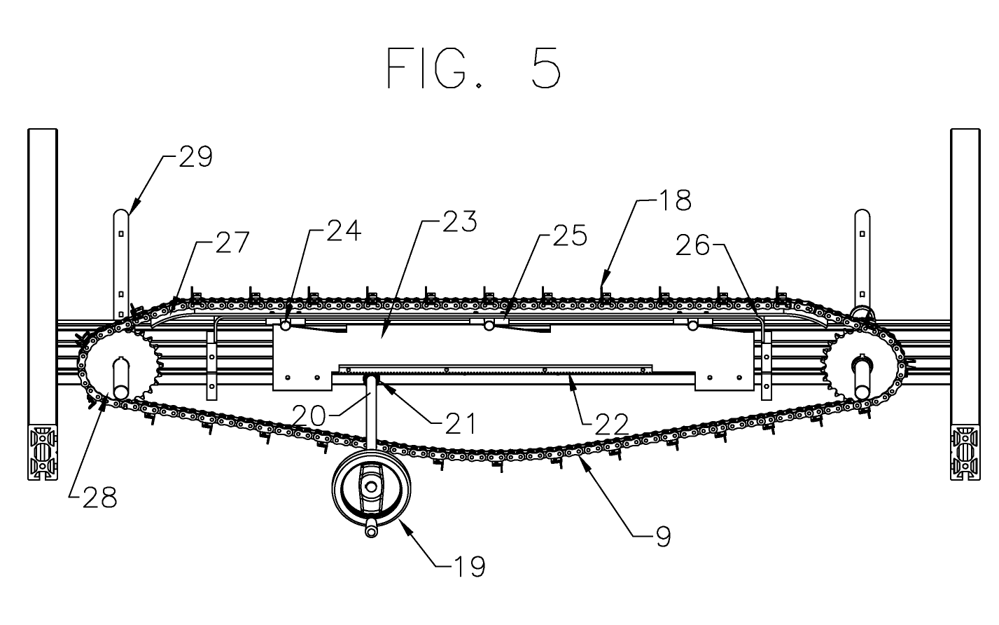

Referring to FIG. 5, attachment chain 9 has a plurality of drive teeth 18 riveted to chain 9. Any or all of the chains 9 can be raised to allow the drive teeth 18 to penetrate into the bottom surface of core 1. Said raising is accomplished by turning hand wheel 19, which turns rod 20, which turns gear 21. Gear 21 engages with rack 22, which imparts a horizontal movement on rack plates 23. Roll pins 24 fit into bearing blocks 25, which are attached to lifting bar 26 and chain guide 27. Turning the hand wheel 19 causes the rack plates 23 to move horizontally, which causes the roll pins to ride up and down the rack plate ramps, which in turn raises and lowers the drive chain. The drive chain rotates on two sprockets, with axles 29, which in turn are driven by a motor through another gear and sprocket (not shown). Said motor is variable in speed by control means. For each of the three drive chains, there is a separate hand wheel controlling the chain height.

Referring to FIG. 1, the foam core is advanced into the coating chamber 30.

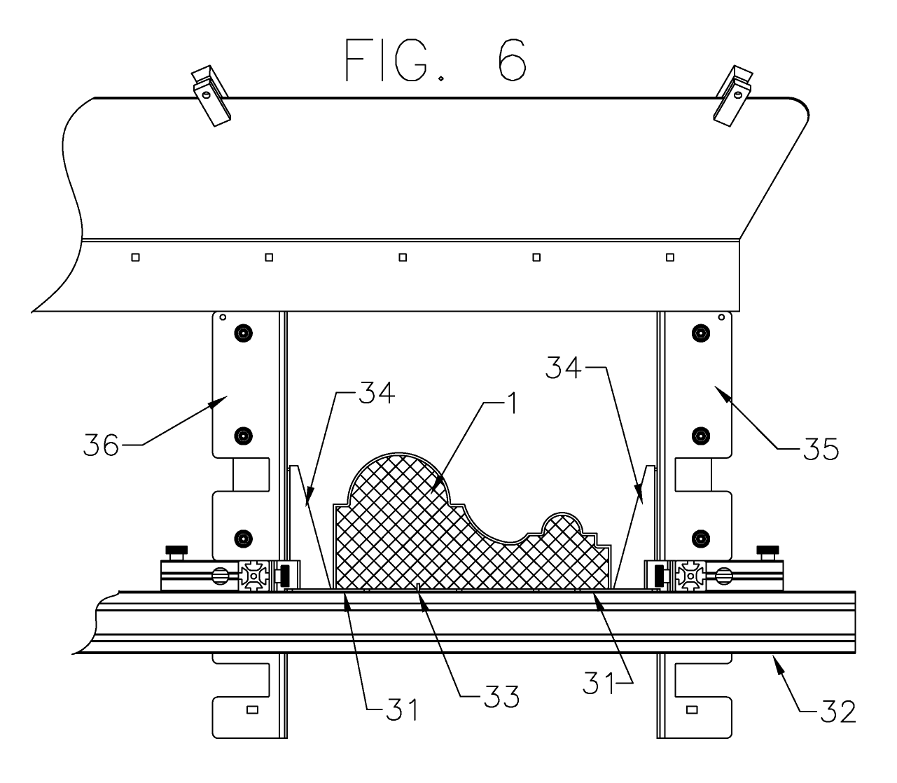

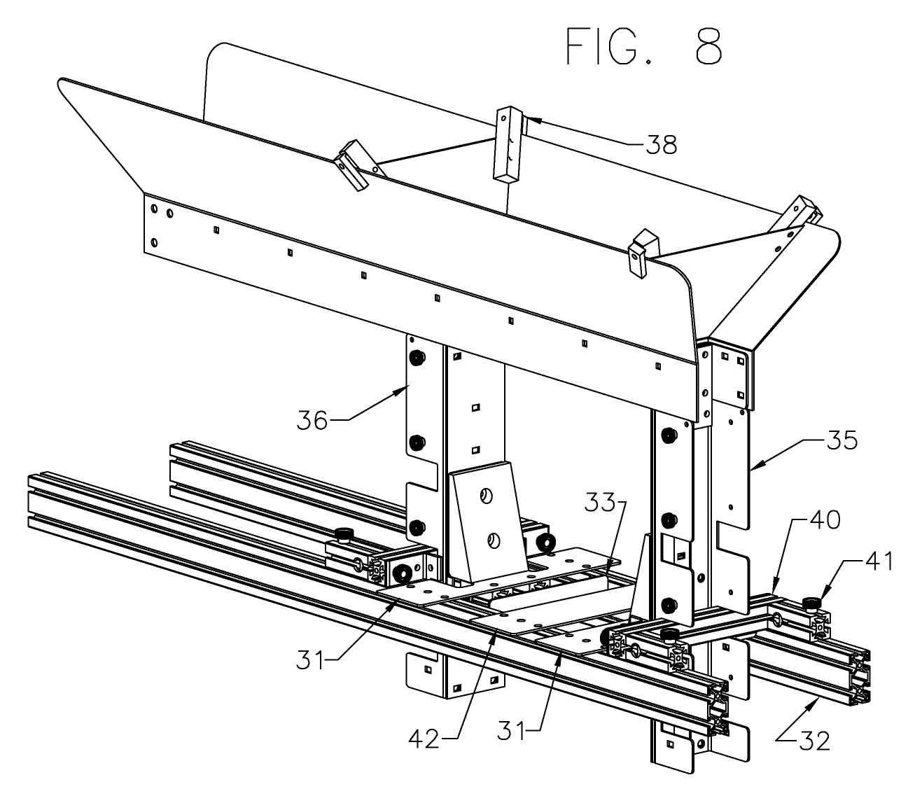

Referring to FIGS. 6 and 8, the foam core 1 slidingly engages the top of two bottom plates 31. The plates 31 are keyed to fit into and slide on top of two slotted extrusions 32. Guide knife 33 is positionable to fit into the slot cut out of the bottom of core 1. Two plastic wedges 34 are bolted to side walls 35 & 36 to funnel the coating material towards the core 1 and away from the inside corners 35-31 and 36-31.

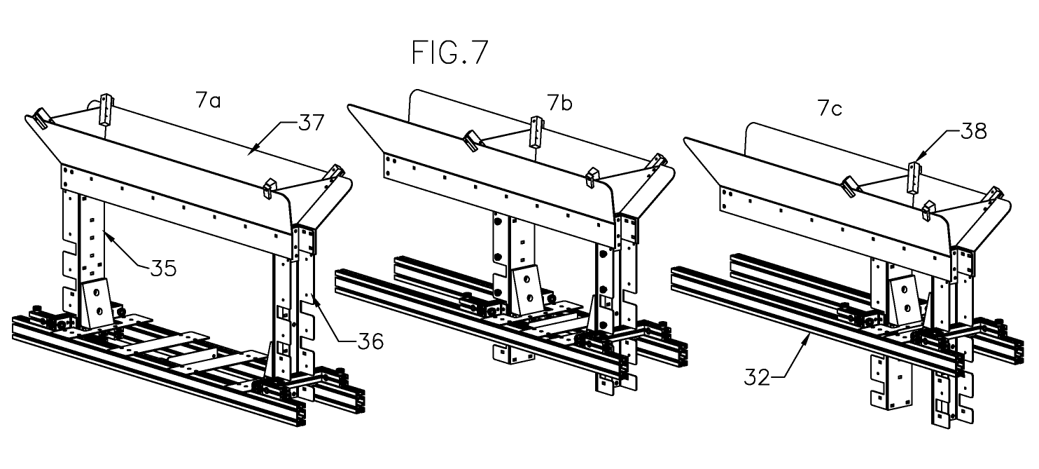

Referring to FIG. 7, sidewall 36 is bolted to funnels 37 and remains fixed together. Sidewall 35 can be slid along the rails 32 to vary the opening size as illustrated by FIGS. 7a, 7b, & 7c. Lock clamps 38 clamp the sidewalls to the funnels 37 once the opening adjustment is achieved. Sidewalls 35 & 36, along with funnels 37 can be adjusted vertically to three selectable heights as illustrated by FIGS. 7a, 7b, & 7c.

Referring to FIG. 8, sidewall supports 40 engage into slots of sidewalls 35 & 36 to suspend the coating chamber assembly 30 on rails 32. Lock knobs 41 are threaded to engage a nut, fitting into the top slots of rails 32. All four lock knobs 41 can be loosened to allow the coating chamber assembly 30 in its entirety, to be slid laterally along rails 32. Loose bottom plate(s) 42 can be inserted to support wider cores if required.

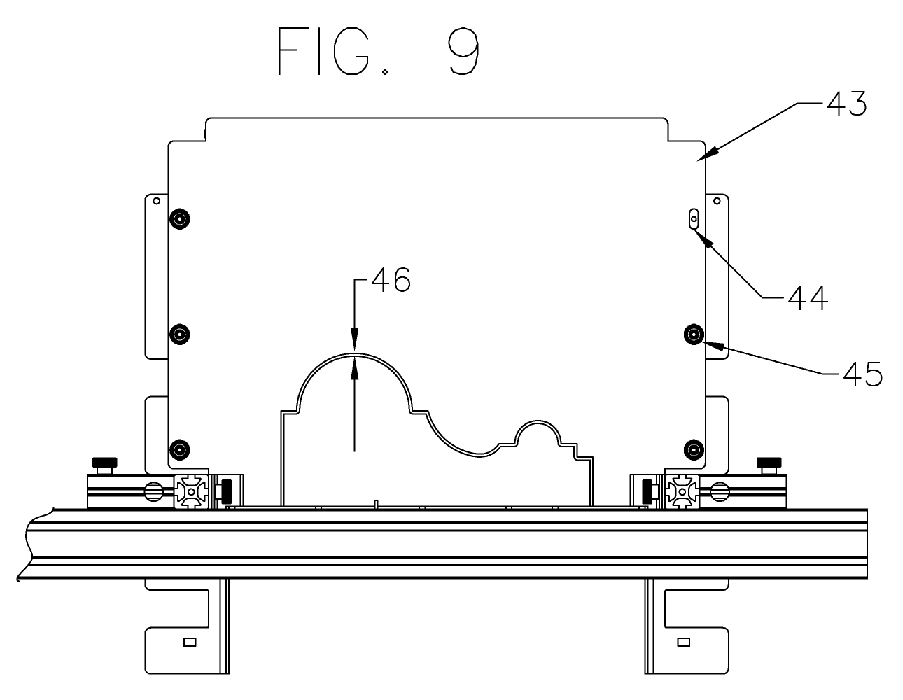

Referring to FIG. 9, output template 43 has slotted holes 44 to allow vertical adjustment, and can be locked in position using hand knobs 45. The adjustment is made to provide the required clearance 46 corresponding to the desired coating thickness.

While many specific details have been disclosed, it will be understood that it is capable of many modifications and that this application is intended to cover any variation, uses, adaptions of the invention, following in general the principals of the invention including such departures from the present disclosure as to come within the knowledge of customary practice in the art, and as may be applied to the essential features hereinbefore set forth and falling within the scope of the invention or the limits of the appended claims.

1. An apparatus for applying a plaster/stucco-like material to a plurality of elongate foam cores having a decorative exposed surface, said apparatus comprising of:
a. Means for constraining elongate foam core in all directions other than forward and reverse to guide the core into a coating chamber.
b. Means for supporting the said core while in the coating chamber.
c. Means for guiding the said core while in the coating chamber.
d. Means for driving the foam core through the apparatus.
e. Means for applying the coating to the surface profile of the said core.

2. An apparatus as claimed in claim 1 wherein said means for constraining the said core includes a plurality of rollers of various lengths, with openings to allow chain drives to engage the said core on the bottom.

3. An apparatus as claimed in claim 1 wherein said constraining include a plurality of hold down wheels that are adjustable vertically and horizontally to constrain the cores from the top against the roller table and the force of engagement from the bottom drive chains.

4. An apparatus as claimed in claim 3 wherein said hold down wheel attaches to a slotted extrusion, which adjust vertically through a lockable tee connection, which slides horizontally on a second slotted extrusion.

5. An apparatus as claimed in claim 1 wherein said constraining includes side fence guides that adjust laterally to constrain the said cores parallel to the forward direction of the drive chains.

6. An apparatus as claimed in claim 5 wherein said fence guides comprise of one inboard guide kept parallel to the direction of advancement by means of two racks and two pinions and one axle, to allow lateral adjustment, and is lockable it its set position.

7. An apparatus as claimed in claim 1 wherein said support in the coating chamber are two or more insertable plates, resting on two slotted extrusions, and adjust laterally independent of the coating chamber.

8. An apparatus as claimed in claim 1 wherein said guiding in the coating chamber is a knife plate, protruding above the support plate level, attached to the two slotted extrusions supporting the coating chamber.

9. An apparatus as claimed in claim 8 wherein said knife plate can be aligned with the bottom slot on the core, and inserted into the slot to keep it aligned.

10. An apparatus as claimed in claim 1 wherein said drive means are three vertically adjustable commercial attachment chains.

11. An apparatus as claimed in claim 10 wherein said vertical adjustment is accomplished with ramped plates and rollers and racks and pinions.

12. An apparatus as claimed in claim 1 wherein said drive means are three drive chains, selectable to be engaged or not engaged, that penetrate into the bottom of the positioned core with a plurality of sharpened metal teeth attached.

13. An apparatus as claimed in claim 12 wherein said engagement can be varied to control the penetration depth into the core.

14. An apparatus as claimed in claim 1 wherein said profile is accomplished with a pair of input and output templates corresponding to the surface profile of the core, specific to the height and width settings of the coating chamber.
